(19) United States
(12) Patent Application Publication
(10) Pub. No.: US 2012/0162240 A1
(43) Pub. Date: Jun. 28, 2012

(54) ELECTRONIC DEVICE AND METHOD FOR OUTPUTTING MEASUREMENT DATA GRAPHICALLY

(75) Inventors: CHIH-KUANG CHANG, Tu-Cheng (TW); XIN-YUAN WU, Shenzhen City (CN); WEI-QUAN WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/217,255

(22) Filed: Aug. 25, 2011

(30) Foreign Application Priority Data
Dec. 25, 2010 (CN) 201010606817.5

(51) Int. Cl. G09G 5/02; G06T 11/20; G06T 11/00

(52) U.S. Cl. 345/589; 345/467; 345/440

(57) ABSTRACT

A method outputs measurement data graphically using an electronic device. The method obtains measurement data of a preselected feature element from an image of a measured object, and further obtains a reference feature element corresponding to the preselected feature element from an image of a reference object. The method further retrieves points of the preselected feature element, connects the retrieved points to obtain a fitted feature element, sets the fitted feature element with different colors, and outputs the fitted feature element with the image of the reference object on a display device of the electronic device.

### BACKGROUND

1. Technical Field

Embodiments of the present disclosure relate to measurement technology, and particularly to an electronic device and method for outputting measurement data graphically using the electronic device.

2. Description of Related Art

Measurement is an important phase in manufacturing and is closely related to product quality. In recent years, point cloud obtaining devices have been used to obtain a point cloud of an object by scanning a large number of points on a surface of the object, processing data in the point cloud, and subsequently extracting boundary elements including boundary points and boundary characteristics of the object, in order to form a profile image of the object. However, the current image measuring method merely outputs measured results (e.g., the form and position tolerances of objects) using a data report (e.g., an EXCEL file). It is inconvenient for a user to check the measured results in the data report manually. Therefore, a more efficient method for outputting measured results is desired.

### BRIEF DESCRIPTION OF THE DRAWINGS

FIG. 1 is a block diagram of one embodiment of an electronic device including an image measuring system.

FIG. 2 is a block diagram of one embodiment of the image measuring system included in the electronic device of FIG. 1.

FIG. 3 is a flowchart of one embodiment of a method for outputting measurement data graphically using the electronic device of the FIG. 1.

FIG. 4 is a detailed flowchart of block 51 in FIG. 3.

FIG. 5 is a detailed flowchart of block S2 in FIG. 3.

FIGS. 6A-6D are exemplary schematic diagrams of relation graphs corresponding to different remarks items of a preselected feature element of a measured object.

FIG. 7 is an exemplary schematic diagram of measurement data outputted with a graphic interface.

FIG. 8 is an exemplary schematic diagram of a plurality of marked numbers in a measured object.

FIG. 9 is an exemplary schematic diagram of a fitted feature element set with different colors.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

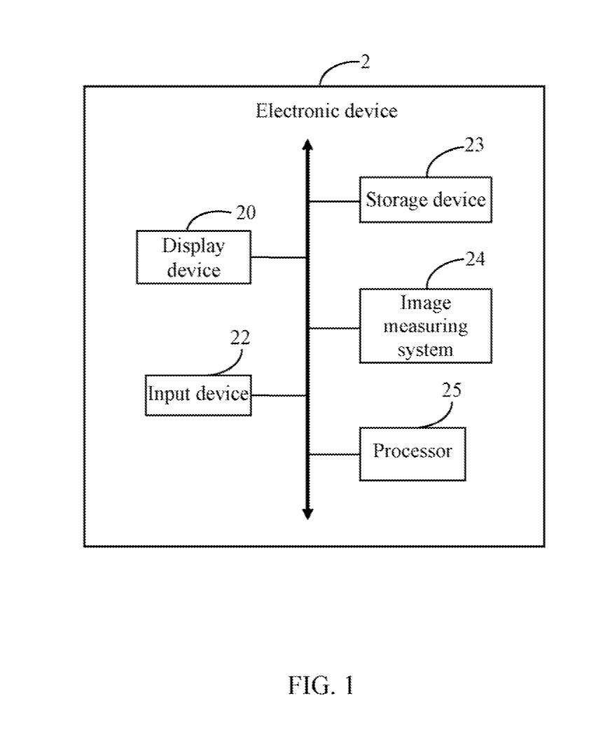

FIG. 1 is a block diagram of one embodiment of an electronic device 2 including an image measuring system 24. In the embodiment, the electronic device 2 further includes a display device 20, an input device 22, a storage device 23, and at least one processor 25. The image measuring system 24 may be used to measure form and position tolerances of a measured object by selecting a feature element to be measured, and to output the form and position tolerances of the measured object on the display device 20 with a graphic interface. In one embodiment, the form and position tolerances may include a form tolerance that is defined as the shape difference between a reference element and the measured element, and a position tolerance that is defined as a locational variation of the feature element as located in the measured object. A detailed description will be given in the following paragraphs. In one embodiment, the feature element may be a line, a plane, a circle, a cylinder, or a sphere, but the disclosure is not limited thereto.

The display device 20 may be used to display the measurement data of the measured object, and the input device 22 may be a mouse or a keyboard used to input computer readable data. The storage device 23 stores the image of the measured object and an image of a reference object corresponding to the measured object.

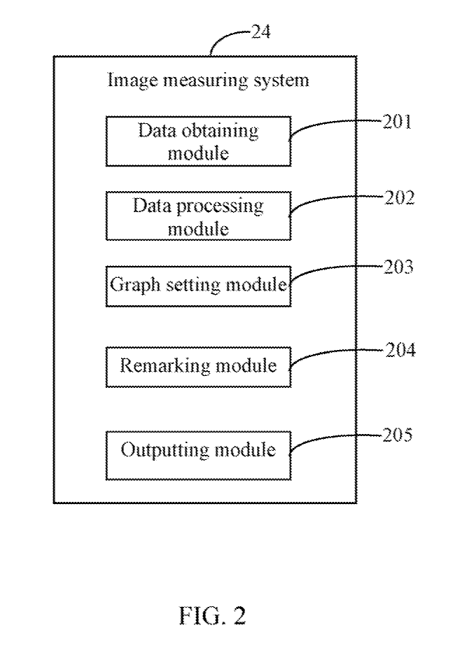

FIG. 2 is a block diagram of one embodiment of the image measuring system 24 in the electronic device 2. In one embodiment, the image measuring system 24 may include one or more modules, for example, a data obtaining module 201, a data processing module 202, a graph setting module 203, a remarking module 204, and an outputting module 205. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives. The one or more modules 201-205 may comprise computerized code in the form of one or more programs that are stored in the storage device 23 or memory of the electronic device 2. The computerized code includes instructions that are executed by the at least one processor 25 to provide functions for the one or more modules 201-205.

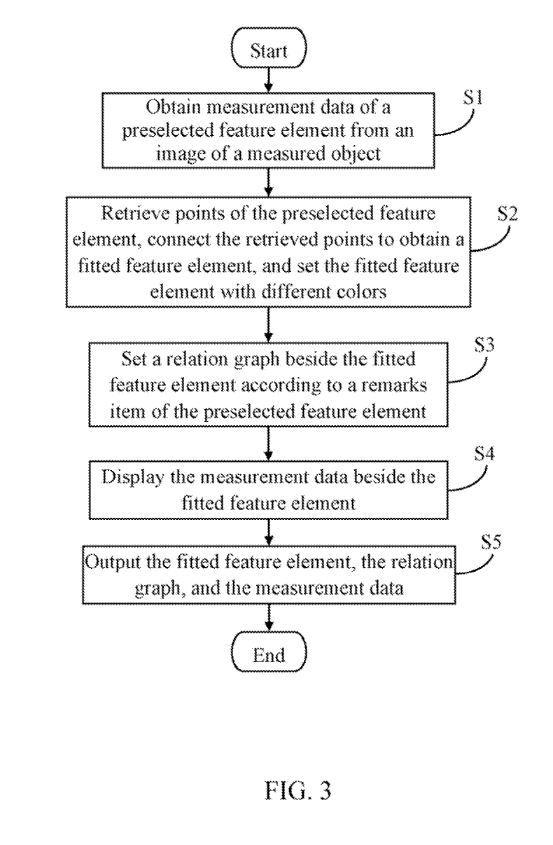

FIG. 3 is a flowchart of one embodiment of a method for outputting measurement data graphically using the electronic device 2. Depending on the embodiment, additional blocks may be added, others removed, and the ordering of the blocks may be changed.

In block S1, the data obtaining module 201 obtains an image of an object (hereinafter refer to as “measured object”) with known measurements from the storage device 23 of the electronic device 2, and obtains the measurement data of a preselected feature element in the image of the measured object. In one embodiment, the image of the measured object may be a computer aided design (CAD) image. The measurement data of the preselected feature element may include, but is not limited to, a name, a preset tolerance range, a remarks item, and the known measurements (i.e., measured results) of the preselected feature element. For example, the measured results may be the length of the preselected feature element along an X-axis or on a Y-axis.

In one embodiment, the tolerance range may be [−0.5, +0.5]. The remarks item of the preselected feature element may include, but is not limited to, a distance or an angle between two adjacent preselected feature elements, a distance from the preselected feature element to the X-axis, or a distance from the preselected feature element to the Y-axis.

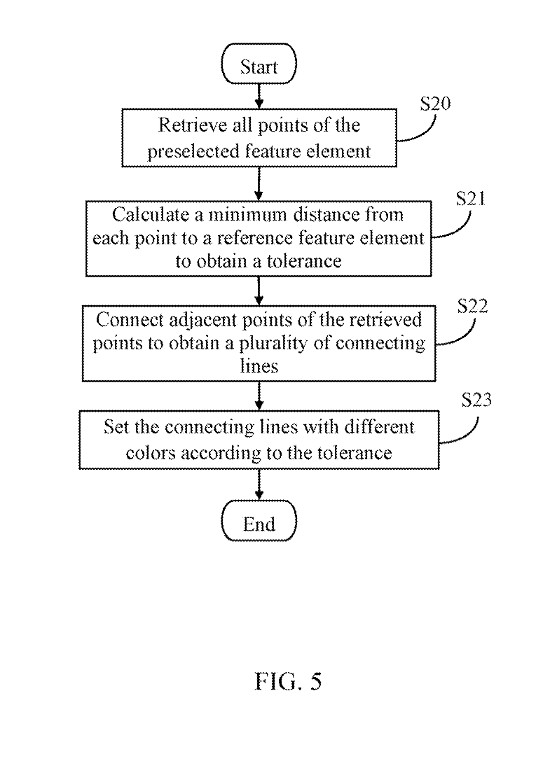

In block S2, the data processing module 202 obtains an image of a reference object corresponding to the measured object from the storage device 23, and obtains a reference feature element corresponding to the preselected feature element from the image of the reference object. Then, the data processing module 202 retrieves points which provides a three-dimensional representation (i.e., point cloud(s)) of the preselected feature element, connects the retrieved points to obtain a fitted feature element, and sets the fitted feature element with different colors according to the tolerances between the fitted feature element and the reference feature element. A detailed description will be given in FIG. 5.

In block S3, the graph setting module 203 sets a relation graph beside the fitted feature element according to the remarks item of the preselected feature element.

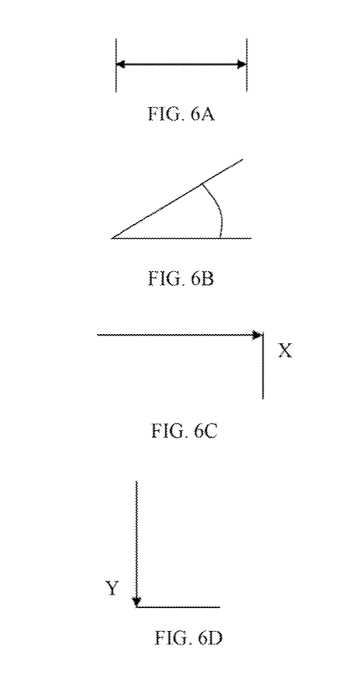

In an exemplary embodiment, if the remarks item of the preselected feature element is the distance between two adjacent preselected feature elements, an example of the relation graph is shown in FIG. 6A. If the remarks item of the preselected feature element is the angle between two adjacent preselected feature elements, an example of the relation graph is shown in FIG. 6B. If the remarks item of the preselected feature element is the distance from the preselected feature element to the X-axis, an example of the relation graph is shown in FIG. 6C. If the remarks item of the preselected feature element is the distance from the preselected feature element to the Y-axis, an example of the relation graph is shown in FIG. 6D.

In block S4, the remarking module 204 displays the measurement data of the preselected feature element beside the fitted feature element.

In block S5, the outputting module 205 outputs the fitted feature element, the relation graph(s), and the measurement data with the image of the reference object on the display device 20, to show the measurement data on the display device 20 with a graphic interface. In one embodiment, the image of the reference object may be a two-dimensional (2D) image or a three-dimensional (3D) image. In other embodiments, the blocks S3 and S4 may be removed, thus, the outputting module 205 merely outputs the fitted feature element with a simple image of the reference object on the display device 20.

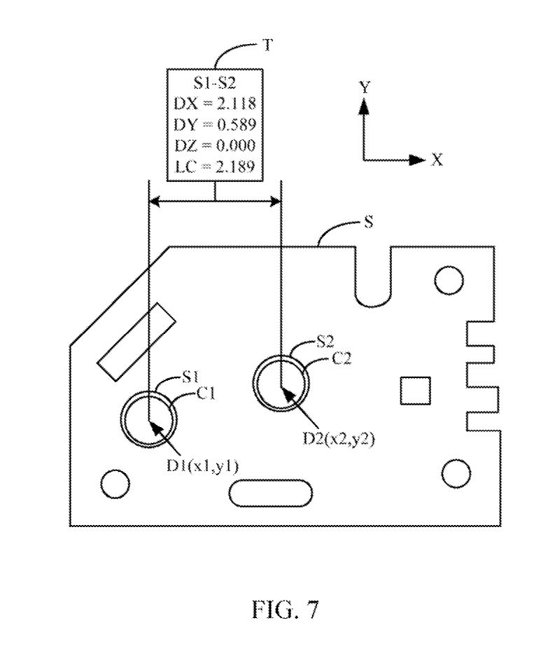

An exemplary schematic diagram of the measurement data outputted together with a graphic interface is shown in FIG. 7, where “S” represents the image of the reference object, “T” represents the measurement data of the preselected feature element, “S1” and “S2” represent two reference feature elements in the reference object “S”, “C1” represents the fitted feature element corresponding to the reference feature element “S1”, “C2” represents the fitted feature element corresponding to the reference feature element “S2”, “D1” represents the center of the fitted feature element “C1”, and “D2” represents the center of the fitted feature element “C2”.

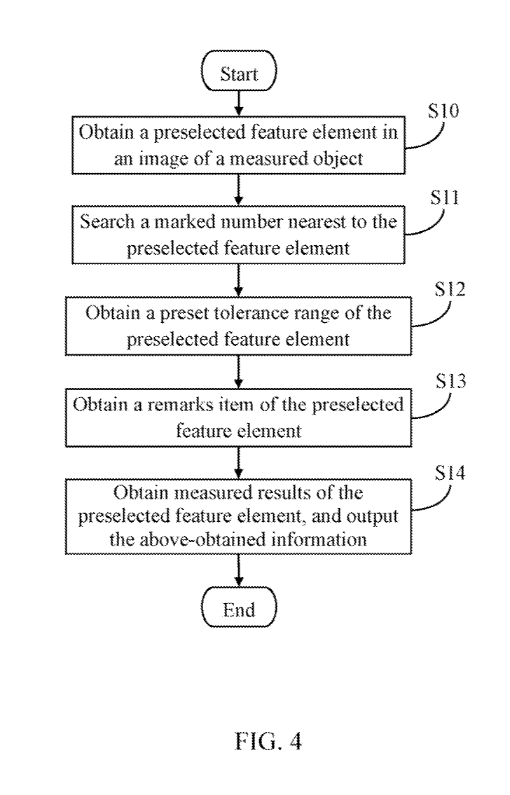

FIG. 4 is a detailed flowchart of block S1 in FIG. 3. Depending on the embodiment, additional blocks may be added, others removed, and the ordering of the blocks may be changed.

In block S10, the data obtaining module 201 obtains a preselected feature element from an image of a measured object. In other embodiments, the user may selects a plurality of feature elements from the image of the measured object at one time.

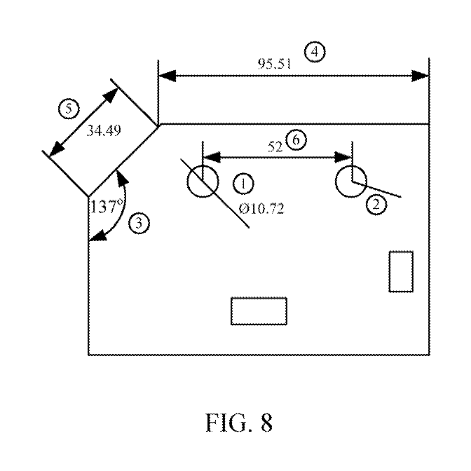

In block S11, the data obtaining module 201 searches for marked number(s) nearest to the preselected feature element. An exemplary schematic diagram of a plurality of marked numbers in the measured object is shown in FIG. 8, such as the encircled digits 1-6 and the corresponding quantities.

In block S12, the data obtaining module 201 obtains a preset tolerance range of the preselected feature element. For example, the preset tolerance range may be [−0.5, +0.5].

In block S13, the data obtaining module 201 obtains a remarks item of the preselected feature element according to the marked number of the preselected feature element. In one embodiment, the marked number of the preselected feature element includes information of the corresponding remarks item. For example, the remarks item of the preselected feature element of the remarks item “3” in FIG. 8 is the angle between two adjacent preselected feature elements.

In block S14, the data obtaining module 201 obtains the measured results of the preselected feature element, and outputs that information in blocks S10-S14. In one embodiment, the measured results may be the length of the preselected feature element along the X-axis or along the Y-axis.

FIG. 5 is a detailed flowchart of block S2 in FIG. 3. Depending on the embodiment, additional blocks may be added, others removed, and the ordering of the blocks may be changed.

In block S20, the data processing module 202 retrieves all points of the preselected feature element, such as P1, P2, P3, P4, . . . , and so on.

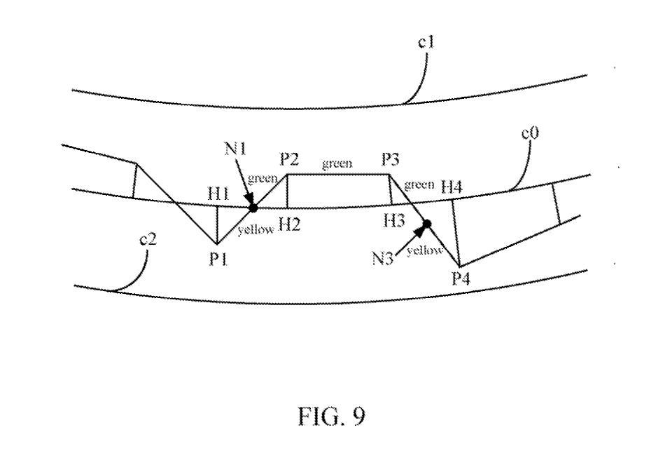

In block S21, the data processing module 202 calculates a minimum distance from each point to the reference feature element to obtain a tolerance(s) between each point and the reference feature element. As shown in FIG. 9, “c0” represents the reference feature element, “c1” represents the maximum limit of the tolerance, and “c2” represents the minimum limit of the tolerance. For example, the minimum distances from the points of P1, P2, P3, and P4 to the reference feature element “c0” are |P1H1|, |P2H2|, |P3H3|, and |P4H4|.

In block S22, the data processing module 202 connects adjacent points of the retrieved points to obtain a plurality of connecting lines, such as P1P2, P2P3, P3P4 in FIG. 9. The connecting lines form the fitted feature element.

In block S23, the data processing module 202 sets the connecting lines with different colors according to the tolerances between each point and the reference feature element, and the preset tolerance range. A detailed description is given in the following paragraphs.

The data processing module 202 determines a first point and a second point adjacent to the first point, and obtains a first tolerance between the first point and the reference feature element, and a second tolerance between the second point and the reference feature element.

If both of the first tolerance and the second tolerance fall in the same sub-range of the preset tolerance range, the data processing module 202 sets a connecting line between the first point and the second point as a preset color.

For example, as shown in FIG. 9, suppose that “P2” represents the first point, and “P3” represents the second point. If the first tolerance of P2 and the second tolerance of P3 fall in the same sub-range (e.g., [0.1, 0.2]) of the preset tolerance range, the color of the connecting line “P2P3” is set as green.

If the first tolerance falls in a first sub-range of the preset tolerance range and the second tolerance falls in a second sub-range of the preset tolerance range, the data processing module 202 calculates a midpoint of the connecting line between the first point and the second point, sets a first connecting line between the first point and the midpoint as a first color of the first sub-range, and sets a second connecting line between the midpoint and the second point as a second color of the second sub-range.

For example, as shown in FIG. 9, suppose that “P3” represents the first point, “P4” represents the second point, and “N3” represents the midpoint of the connecting line “P3P4”. If the first tolerance of P3 falls in a first sub-range (e.g., [0.1-0.2]) of the preset tolerance range, and the second tolerance of P4 falls in a second sub-range (e.g., (0.2-0.3]) of the preset tolerance range, the color of the first connecting line “P3N3” is set as green, and the color of the second connecting line “P4N3” is set as yellow.

In other embodiments, if the first tolerance or the second tolerance falls outside the preset tolerance range, the data processing module 202 sets the connecting line between the first point and the second point as red.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized-implemented method for outputting measurement data graphically using an electronic device, the method comprising:
obtaining an image of a measured object from a storage device of the electronic device, and obtaining measurement data of a preselected feature element from the image of the measured object;
obtaining a reference feature element corresponding to the preselected feature element from an image of a reference object, retrieving points of the preselected feature element, connecting the retrieved points to obtain a fitted feature element, and setting the fitted feature element with different colors according to a tolerance between the fitted feature element and the reference feature element; and
outputting the fitted feature element with the image of the reference object to graphically display the measurement data on a display device of the electronic device.

2. The method according to claim 1, wherein the measurement data of the preselected feature element comprise a name, a preset tolerance range, a remarks item, and measured results of the preselected feature element.

3. The method according to claim 2, wherein the remarks items of the preselected feature element comprise a distance or an angle between two adjacent preselected feature elements, a distance from the preselected feature element to an X-axis, or a distance form the preselected feature element to a Y-axis.

4. The method according to claim 3, further comprising:
setting a relation graph beside the fitted feature element according to the remarks item of the preselected feature element; and
displaying the measurement data of the preselected feature element beside the fitted feature element.

5. The method according to claim 1, wherein the step of setting the fitted feature element with different colors comprises:
retrieving all points of the preselected feature element;
calculating a minimum distance from each point to the reference feature element to obtain a tolerance between each point and the reference feature element;
connecting adjacent points of the retrieved points to obtain a plurality of connecting lines, the connecting lines forming the fitted feature element; and
setting the connecting lines with different colors according to the tolerance between each point and the reference feature element, and the preset tolerance range.

6. The method according to claim 5, wherein the step of setting the connecting lines with different colors comprises:
determining a first point and a second point adjacent to the first point, and obtaining a first tolerance between the first point and the reference feature element, and a second tolerance between the second point and the reference feature element;
setting a connecting line between the first point and the second point as a preset color upon the condition that both of the first tolerance and the second tolerance fall in the same sub-range of the preset tolerance range; or
calculating a midpoint of the connecting line between the first point and the second point upon the condition that the first tolerance falls in a first sub-range of the preset tolerance range and the second tolerance falls in a second sub-range of the preset tolerance range, setting a first connecting line between the first point and the midpoint as a first color of the first sub-range, and setting a second connecting line between the midpoint and the second point as a second color of the second sub-range.

7. An electronic device, comprising:
a storage device;
at least one processor; and
one or more modules that are stored in the storage device and are executed by the at least one processor, the one or more modules comprising instructions:
to obtain an image of a measured object from the storage device of the electronic device, and obtain measurement data of a preselected feature element from the image of the measured object;
to obtain a reference feature element corresponding to the preselected feature element from an image of a reference object, retrieve points of the preselected feature element, connect the retrieved points to obtain a fitted feature element, and set the fitted feature element with different colors according to a tolerance between the fitted feature element and the reference feature element; and
to output the fitted feature element with the image of the reference object to graphically display the measurement data on a display device of the electronic device.

8. The electronic device according to claim 7, wherein the measurement data of the preselected feature element comprise a name, a preset tolerance range, a remarks item, and measured results of the preselected feature element.

9. The electronic device according to claim 8, wherein the remarks items of the preselected feature element comprise a distance or an angle between two adjacent preselected feature elements, a distance from the preselected feature element to an X-axis, or a distance form the preselected feature element to a Y-axis.

10. The electronic device according to claim 9, wherein the one or more modules further comprise instructions:
to set a relation graph beside the fitted feature element according to the remarks item of the preselected feature element; and
to display the measurement data of the preselected feature element beside the fitted feature element.

11. The electronic device according to claim 7, wherein the instruction of setting the fitted feature element with different colors comprises:
retrieving all points of the preselected feature element;
calculating a minimum distance from each point to the reference feature element to obtain a tolerance between each point and the reference feature element;
connecting adjacent points of the retrieved points to obtain a plurality of connecting lines, the connecting lines forming the fitted feature element; and
setting the connecting lines with different colors according to the tolerance between each point and the reference feature element, and the preset tolerance range.

12. The electronic device according to claim 11, wherein the instruction of setting the connecting lines with different colors comprises:
determining a first point and a second point adjacent to the first point, and obtaining a first tolerance between the first point and the reference feature element, and a second tolerance between the second point and the reference feature element;
setting a connecting line between the first point and the second point as a preset color upon the condition that both of the first tolerance and the second tolerance fall in the same sub-range of the preset tolerance range; or
calculating a midpoint of the connecting line between the first point and the second point upon the condition that the first tolerance falls in a first sub-range of the preset tolerance range and the second tolerance falls in a second sub-range of the preset tolerance range, setting a first connecting line between the first point and the midpoint as a first color of the first sub-range, and setting a second connecting line between the midpoint and the second point as a second color of the second sub-range.

13. A non-transitory storage medium having stored thereon instructions that, when executed by a processor of an electronic device, causes the processor to perform a method for outputting measurement data graphically using the electronic device, the method comprising:
obtaining an image of a measured object from a storage device of the electronic device, and obtaining measurement data of a preselected feature element from the image of the measured object;
obtaining a reference feature element corresponding to the preselected feature element from an image of a reference object, retrieving points of the preselected feature element, connecting the retrieved points to obtain a fitted feature element, and setting the fitted feature element with different colors according to a tolerance between the fitted feature element and the reference feature element; and
outputting the fitted feature element with the image of the reference object to graphically display the measurement data on a display device of the electronic device.

14. The non-transitory storage medium according to claim 13, wherein the measurement data of the preselected feature element comprise a name, a preset tolerance range, a remarks item, and measured results of the preselected feature element.

15. The non-transitory storage medium according to claim 14, wherein the remarks items of the preselected feature element comprise a distance or an angle between two adjacent preselected feature elements, a distance from the preselected feature element to an X-axis, or a distance form the preselected feature element to a Y-axis.

16. The non-transitory storage medium according to claim 15, wherein the method further comprises:
setting a relation graph beside the fitted feature element according to the remarks item of the preselected feature element; and
displaying the measurement data of the preselected feature element beside the fitted feature element.

17. The non-transitory storage medium according to claim 13, wherein the step of setting the fitted feature element with different colors comprises:
retrieving all points of the preselected feature element;
calculating a minimum distance from each point to the reference feature element to obtain a tolerance between each point and the reference feature element;
connecting adjacent points of the retrieved points to obtain a plurality of connecting lines, the connecting lines forming the fitted feature element; and
setting the connecting lines with different colors according to the tolerance between each point and the reference feature element, and the preset tolerance range.

18. The non-transitory storage medium according to claim 17, wherein the step of setting the connecting lines with different colors comprises:
determining a first point and a second point adjacent to the first point, and obtaining a first tolerance between the first point and the reference feature element, and a second tolerance between the second point and the reference feature element;
setting a connecting line between the first point and the second point as a preset color upon the condition that both of the first tolerance and the second tolerance fall in the same sub-range of the preset tolerance range; or
calculating a midpoint of the connecting line between the first point and the second point upon the condition that the first tolerance falls in a first sub-range of the preset tolerance range and the second tolerance falls in a second sub-range of the preset tolerance range, setting a first connecting line between the first point and the midpoint as a first color of the first sub-range, and setting a second connecting line between the midpoint and the second point as a second color of the second sub-range.

19. The non-transitory storage medium according to claim 13, wherein the medium is selected from the group consisting of a hard disk drive, a compact disc, a digital video disc, and a tape drive.
